(19) United States
(12) Patent Application Publication
(10) Pub. No.: US 2016/0351294 A1
(43) Pub. Date: Dec. 1, 2016

(54) CABLE STRUCTURE WITH INNER INSULATION LAYER

(71) Applicant: WANSHIH ELECTRONIC CO., LTD., New Taipei City (TW)

(72) Inventor: Ming-Li TSAI, New Taipei City (TW)

(21) Appl. No.: 14/721,241

(22) Filed: May 26, 2015

(51) Int. Cl. H01B 7/08; H01B 11/20; H01B 7/00

(52) U.S. Cl. CPC H01B 7/08; H01B 7/0045; H01B 11/20

(57) ABSTRACT

A cable structure includes a cable body and an outer cover layer. The cable body includes a first transmission line set. The first transmission line set includes a plurality of first transmission lines. Each of the first transmission lines includes a first insulation outer layer. The first insulation outer layers are connected side by side. The outer cover layer covers the cable body. Accordingly, a production process is simplified, and a welding process for making an electrical jumper connection is obviated, and thus production time is reduced.

### BACKGROUND

1. Technical Field

The present invention relates to a cable and, in particular, to a cable structure including therein transmission lines connected side by side to form a flat cable.

2. Related Art

The conventional cable such as a USB 3.1 cable or a composite cable for use in high frequency transmission includes transmission lines for transmitting power signals and digital/analog signals, so the transmission lines need to be designated by different colors during production, which results in complexity in a production process.

Furthermore, since the cable is used to transmit power signals and digital/analog signals, an electrical wire and a coaxial wire are both adopted and are mixed in the cable, and as a result, it is necessary to make an electrical jumper connection when performing welding on a printed circuit board (PCB) or a flexible printed circuit board (FPCB), thereby leading to problems such as long production time and a high production cost.

In view of the foregoing, the inventor made various studies to improve the above-mentioned problems, on the basis of which the present invention is accomplished.

### BRIEF SUMMARY

The present invention relates to a cable structure which can connect the same type of transmission lines to form a transmission line set in a flexible flat cable form, so as to simplify a production process, obviate a welding process for making an electrical jumper connection, and reduce production time.

Accordingly, the present invention provides a cable structure, comprising: a cable body including a first transmission line set, the first transmission line set including a plurality of first transmission lines, each of the first transmission lines including a first insulation outer layer, the first insulation outer layers being connected side by side; and an outer cover layer covering the cable body.

Compared to conventional techniques, the present invention includes the following effects. The same type of transmission lines are connected together to form a transmission line set in a flexible flat cable form, and such that coloring work for designating different transmission lines by different colors is less required, thereby simplifying a production process. Moreover, welding can be directly conducted on a printed circuit board or a flexible printed circuit board without making an electrical jumper connection, thereby reducing production time.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a perspective view of a first transmission line set according to the present invention.

FIG. 2 is a cross-sectional view of the first transmission line set according to the present invention.

FIG. 3 is a perspective view of a second transmission line set according to the present invention.

FIG. 4 is a cross-sectional view of the second transmission line set according to the present invention.

FIG. 5 is a cross-sectional view of a cable structure according to the present invention.

FIG. 6 is a lateral view of the cable structure according to the present invention.

### DETAILED DESCRIPTION

Detailed descriptions and technical contents of the present invention are illustrated below in conjunction with the accompany drawings. However, it is to be understood that the descriptions and the accompany drawings disclosed herein are merely illustrative and exemplary and not intended to limit the scope of the present invention.

The present invention provides a cable structure in which all transmission lines are all changed into first transmission lines or are all changed into second transmission lines. The first transmission lines are connected together to form a first transmission line set, and the second transmission lines are connected together to form a second transmission line set, thereby facilitating production or manufacturing.

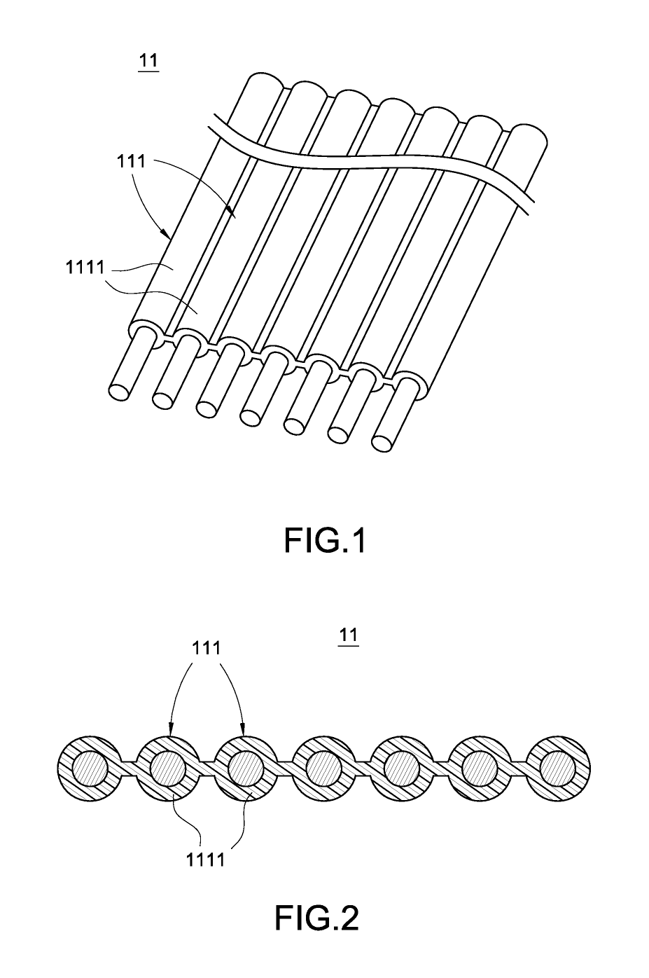

Referring to FIGS. 1 and 2, a first transmission line set 11 includes a plurality of first transmission lines 111. Each of the first transmission lines 111 includes a first insulation outer layer 1111 covering an exterior surface of each of the first transmission lines 111. The first insulation outer layers 1111 are connected side by side to form the first transmission line set 11 in a flexible flat cable form.

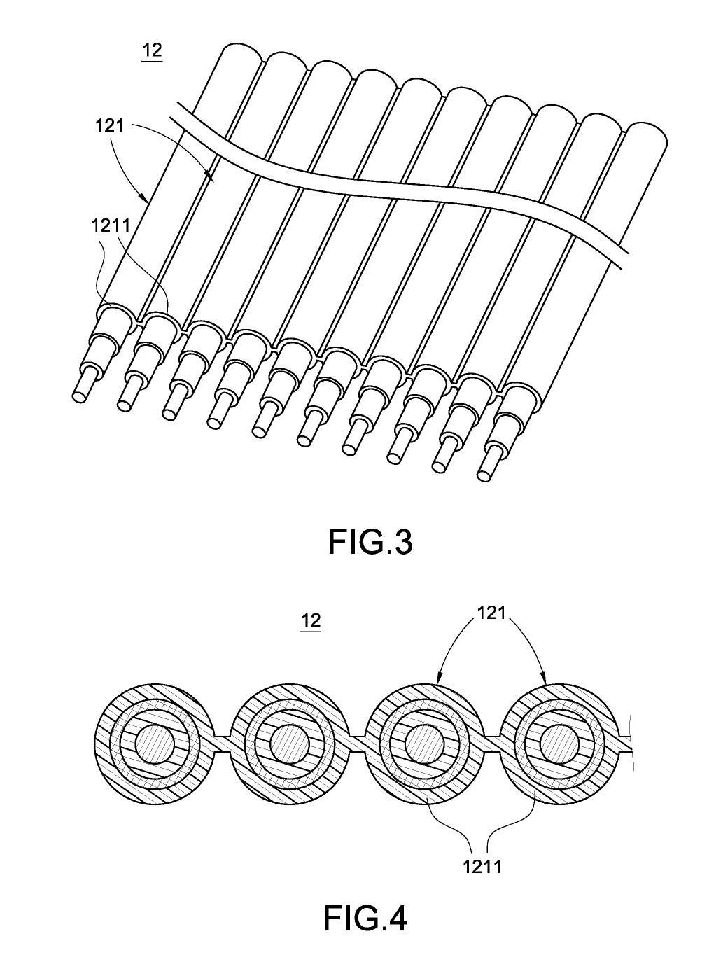

Referring to FIGS. 3 and 4, a second transmission line set 12 includes a plurality of second transmission lines 121. Each of the second transmission lines 121 includes a second insulation outer layer 1211 covering an exterior surface of each of the second transmission lines 121. The second insulation outer layers 1211 are connected side by side so as to form the second transmission line set 12 in the flexible flat cable form.

As shown in the figures, each of the first transmission lines 111 of the first transmission line set can be an electrical wire, and each of the second transmission lines 121 of the second transmission line set 12 can be a coaxial wire; however, the present invention is not limited thereto, so each of the first transmission lines 111 can be a coaxial wire, and each of the second transmission lines 121 can be an electrical wire (not illustrated).

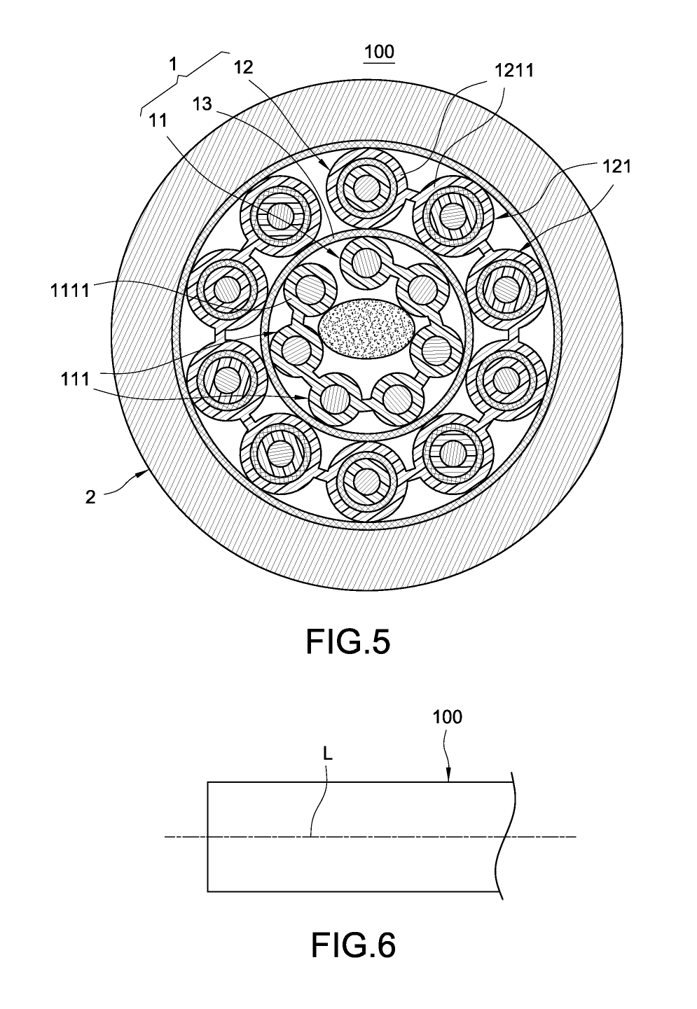

Referring to FIGS. 5 and 6, the cable structure 100 of the present invention includes a cable body 1 and an outer cover layer 2 covering the cable body 1. The cable body 1 defines a central axis L. To be specific, the central axis L is defined according to an axle center of the cable body 1.

The cable body 1 includes the first transmission line set 11 in the flexible flat cable form. The cable body 1 exemplified in the present embodiment further includes a shielding layer 13 and the second transmission line set 12 in the flexible flat cable form.

The first transmission line set 11 surrounds the central axis L to form a circular shape, a helix shape, or other suitable shapes; the present invention is not limited thereto. According to the present embodiment, the first transmission line set 11 forms a circular shape as an example. Each of the first transmission lines 111 of the first transmission line set 11 is an electrical wire or a coaxial wire.

The second transmission line set 12 surrounds the central axis L to form a circular shape, a helix shape, or other shapes; the present invention is not limited thereto. According to the present embodiment, the second transmission line set 12 forms a circular shape as an example, and the second transmission line set 12 covers the first transmission line set 11. Each of the second transmission lines 121 of the second transmission line set 12 can be a coaxial wire or an electrical wire.

The shielding layer 13 is disposed between, and provides shielding between, the first transmission line set 11 and the second transmission line set 12. To be specific, as shown in FIG. 5, the shielding layer 13 covers the first transmission line set 11, the second transmission line set 12 covers the shielding layer 13, so that shielding is provided between the first transmission line set 11 and the second transmission line set 12 for avoiding disturbing each other.

Accordingly, coloring work for indicating different transmission lines by different colors is less required, thereby simplifying a production process. The transmission line set 11 or 12 can be spread out to form the flat cable form, so welding can be directly conducted on a printed circuit board (PCB) or a flexible printed circuit board (FPCB) without making an electrical jumper connection. Furthermore, since a pin layout can be created directly on the PCB or the FPCB, production time can be reduced.

In practice, the outer cover layer 2 of the cable structure 100 of the present invention covers the cable body 1. The cable body 1 can include only the first transmission line set 11 (a first type, not illustrated), circling to form any suitable shape, can include only the second transmission line set 12 (a second type, not illustrated) circling to form any suitable shape, or can include both the first transmission line set 11 and the second transmission line set 12 circling to form any suitable shapes (a third type, as shown in FIG. 5); the present invention is not limited thereto. The above-mentioned effects can be achieved as long as the transmission line set 11 or 12 can be formed into a flexible flat cable.

Furthermore, in the third type, it is feasible to make only the first transmission line set 11 or only the second transmission line set 12 into the flexible flat cable form; although the present invention is not limited thereto, the most production difficulties can be overcome when the first transmission line set 11 in an inner circle of the cable body 1 is made into the flexible flat cable form. The second transmission line set 12 in an outer circle of the cable body 1 is not necessary to be made into the flexible flat cable form, but, nevertheless, it is okay to make only the second transmission line set 12 in the outer circle of the cable body 1 into the flexible flat cable form.

For example, in a conventional USB 3.1 cable structure (not illustrated), there are generally two groups of transmission lines. The transmission lines of the first group are mostly electrical wires but include two coaxial wires (designated by color as: USB 2.0—white and green). The transmission lines of the second group are mostly coaxial wires, but include one electrical wire (designated by color as: power source—red).

If the two coaxial wires of the transmission lines of the first group change in position to the second group of the transmission lines, and the one electrical wire of the transmission lines of the second group changes in position to the first group of the transmission lines, the transmission lines of the first group are all electrical wires such that they can be connected to form a flexible flat cable, and the transmission lines of the second group of the transmission lines are all coaxial wires such that they also can be connected to form a flexible flat cable. By doing so, the conventional USB 3.1 cable structure may have the foregoing effects of the present invention.

In summary, compared with the conventional techniques, the present invention has the following effects. Coloring work for indicating different transmission lines by different colors is less required, and thus a production process is simplified. The transmission line set 11 or 12 can be spread out and transformed from the circular shape or the helix shape to the flat cable form, so welding can be directly conducted on a printed circuit board (PCB) or a flexible printed circuit board (FPCB) without making an electrical jumper connection (the reason is that a pin layout can be created directly on the PCB or the FPCB), thereby reducing production time.

It is to be understood that the above descriptions are merely preferable embodiments of the present invention and are not intended to limit the scope of the present invention. Equivalent changes and modifications made in the spirit of the present invention are regarded as falling within the scope of the present invention.

1. A cable structure with inner insulation layer, comprising:
a cable body including a first transmission line set, the first transmission line set including a plurality of first transmission lines, each of the first transmission lines including a first insulation outer layer, a first elongated insulation section being connected between outer surfaces of any two of the first insulation outer layers adjacent to each other; and
an outer cover layer covering the cable body.

2. The cable structure of claim 1, wherein each of the first transmission lines is an electrical wire.

3. The cable structure of claim 1, wherein each of the first transmission lines is a coaxial wire.

4. The cable structure of claim 1, wherein the cable body defines a central axis according to an axle center of the cable body, and the first transmission line set surrounds the central axis.

5. The cable structure of claim 4, wherein the first transmission line set surrounds the central axis to form a helix shape.

6. The cable structure of claim 1, wherein the cable body further includes a second transmission line set, the second transmission line set includes a plurality of second transmission lines, each of the second transmission lines includes a second insulation outer layer, a second elongated insulation section being connected between outer surfaces of any two of the second insulation outer layers.

7. The cable structure of claim 6, wherein the cable body defines a central axis according to an axle center of the cable body, the second transmission line set surrounds the central axis, and the second transmission line set covers the first transmission line set.

8. The cable structure of claim 6, wherein each of the first transmission lines is an electrical wire, and each of the second transmission lines is a coaxial wire.

9. The cable structure of claim 7, wherein each of the first transmission lines is an electrical wire, and each of the second transmission lines is a coaxial wire.

10. The cable structure of claim 6, wherein each of the first transmission lines is a coaxial wire, and each of the second transmission lines is an electrical wire.

11. The cable structure of claim 7, wherein each of the first transmission lines is a coaxial wire, and each of the second transmission lines is an electrical wire.

12. The cable structure of claim 6, wherein the cable body includes a shielding layer, and the shielding layer is disposed between, and provides shielding between, the first transmission line set and the second transmission line set.

13. The cable structure of claim 7, wherein the cable body further includes a shielding layer, and the shielding layer is disposed between, and provides shielding between, the first transmission line set and the second transmission line set.

14. The cable structure of claim 1, wherein a thickness of each of the first elongated insulation sections is smaller than a diameter of a wire core of each of the first transmission lines.
